(19) United States
(12) Patent Application Publication
(10) Pub. No.: US 2019/0016402 A1
(43) Pub. Date: Jan. 17, 2019

(54) SEAT POST FOR BICYCLE

(71) Applicant: WEI HAU ACCESSORIES CO., LTD., Changhua County (TW)

(72) Inventor: Yuan-Hsin Huang, Changhua County (TW)

(21) Appl. No.: 15/651,009

(22) Filed: Jul. 17, 2017

(51) Int. Cl. B62J 1/08; B62K 19/30

(52) U.S. Cl. CPC B62J 1/08; B62J 1/00; B62K 19/30

(57) ABSTRACT

The present invention provides a bicycle seat post with one end thereof having a rail support for securing two rails of a bicycle seat. The rail support comprises an accommodation member having an aperture, an adjusting member detachably engaged within the aperture of the accommodation member, and the adjusting member having at least one displacement hole, and a first clamp assembly and a second clamp assembly disposed on two sides of the displacement hole of the adjusting member to secure the two rails of the seat. The rotational mechanism of the present invention is designed with the displacement hole being disposed within the adjusting member, therefore facilitating the rotary adjustment of the seat by adjusting the position of the displacement hole and securing the relative position of the first and second clamp assemblies.

### FIELD OF THE INVENTION

The present invention relates to a bicycle seat post, and particularly to a seat post having one end with a rail support that allows ease displacement of a bicycle seat and adjustment of its inclination angle.

### BACKGROUND OF THE INVENTION

Recently bicycle industry developing well and to provide easily adjustable assembly with high strength while at the same time being light weight been the object for the manufacturer.

For safety and firmness concerns, conventional bicycle components permit only very limited adjustment ranges of the seat. For example, the seat and seat post securing together by one simple clamp and then fastening by screw to make the seat stable during riding. However, there is a need for providing convenient adjustment of the seat of the bicycle that may be adapted to different body sizes, particularly leg lengths, of bicycle riders.

There are a number of products currently available on the market for solving this problem, as shown in FIG. 1, which is the bicycle seat adjusting device disclosed in U.S. Pat. No. 5,295,727, which comprises an adjusting shaft is placed within the U-shaped support at the upper end of the seat post. The adjusting shaft has a plurality of radial positioning holes for mounting an adjusting level, only the adjusting lever has to be turned in order to loosen the hexagonal bolts and consequently to loosen the seat, and then the seat can be adjusted to suitable position of the rider.

However, the structure of this device is more complex, and it is poor performance by tightening the adjusting lever to fix the seat. Furthermore, after a long period of use there will be loose problems, causing the seat swing and leading the rider in dangerous situation. In addition, in order to allow the rider to easily adjust the seat, the length of the adjusting lever is easily exposed, so that the influence, the convenience and the safety of rider is also needs to be considered.

### SUMMARY OF THE INVENTION

In order to solve the above-mentioned problems, it is an object of the present invention to provide a bicycle seat post which is easy to adjust the position of the seat, and more particularly to a bicycle seat having a rail support, which can easily moving the seat forward or backward or adjust its inclination and also to achieve the needs of stability and safety.

The present invention provides a seat post for a bicycle with one end thereof having a rail support for securing two rails of a seat, wherein the rail support comprising: an accommodation member having an aperture; an adjusting member detachably engaged within the aperture of the accommodation member and having at least one displacement hole; a first clamp assembly disposed on one side of the displacement hole of the adjusting member for clamping one of the two rails, and the first clamp assembly having a first through-hole; a second clamp assembly disposed on another side of the displacement hole of the adjusting member for clamping another of the two rails, and the second clamp assembly having a second through-hole; and a fastener inserting through the first through-hole of first clamp assembly, the displacement hole of the adjusting member, and the second through-hole of the second clamp assembly to secure the adjusting member to the accommodation member.

In one embodiment of the present invention, the first clamp assembly comprises a first inner clamp, a first outer clamp, and a first channel formed between the first inner clamp and the first outer clamp for receiving the rails of the seat. The first inner clamp further comprises a first conical protrusion disposed on a side of the first inner clamp facing to the adjusting member and for engaging the displacement hole of the adjusting member. The first inner clamp comprises a threaded structure facing to the adjusting member. The second clamp assembly comprises a second inner clamp, a second outer clamp, and a second channel formed between the second inner clamp and the second outer clamp for receiving the rails of the seat. The second inner clamp comprises a second conical protrusion disposed on a side of the second inner clamp facing to the adjusting member and for engaging the displacement-hole of the adjusting member. The second inner clamp comprises a threaded structure facing to the adjusting member. The aperture of the accommodation member has a shape corresponding to an exterior of the adjusting member so that the adjusting member can be engaged within the accommodation member. The shape of the aperture of the accommodation member is one of an N-sided regular or an oblong, wherein the N is greater than or equal to 3. An elastic member disposed between the aperture of the accommodation member and the adjusting member.

Another object of the present invention is to provide a seat post for a bicycle comprising a seat, two rails of the seat, a seat post having one end thereof mounted with a rail support to clamp two rails of the seat, the rail support comprising: an accommodation member having an aperture; an adjusting member detachably engaged within the aperture of the accommodation member and having at least one displacement hole; wherein a shape of an exterior of the adjusting member is symmetrical to an axis of the adjusting member and the aperture of the accommodation member further comprises a plurality of grooves disposed radially inward and having a shape corresponding to the exterior of the adjusting member for engaging with the adjusting member. And the rail support further comprises a pair of clamp assemblies disposed on two sides of the displacement hole of the adjusting member for clamping rails.

The present invention provides a seat post used to adjust the position of the seat easily and conveniently. The rider can operate easily without screws, locking components or the likes and complex assembling steps, lead to comfort on extended rides and also to meet the safety requirement.

Various other objects, advantages and features of the present invention will become readily apparent from the ensuing detailed description, and the novel features will be particularly pointed out in the appended claims.

### BRIEF DESCRIPTION OF FIGURES

The following detailed descriptions, given by way of example, and not intended to limit the present invention solely thereto, will be best be understood in conjunction with the accompanying figures:

FIG. 1 illustrates an exploded perspective view of a conventional bicycle seat adjusting device.

FIG. 2 illustrates a side view of a bicycle seat post according to an embodiment of the present invention.

FIG. 3 illustrates an exploded perspective view of a rail support according to an embodiment of the present invention.

FIGS. 4A to 4F illustrate side view of decomposition movement of rotary adjusting member according to an embodiment the present invention.

FIGS. 5A to 5I illustrate side view of the accommodation member and the adjusting member according to various embodiments of the present invention.

FIG. 6 illustrates a side view of the rail support connected with seat post according to an embodiment of the present invention.

FIG. 7 illustrates an exploded perspective view of a second clamp assembly according to an embodiment of the present invention.

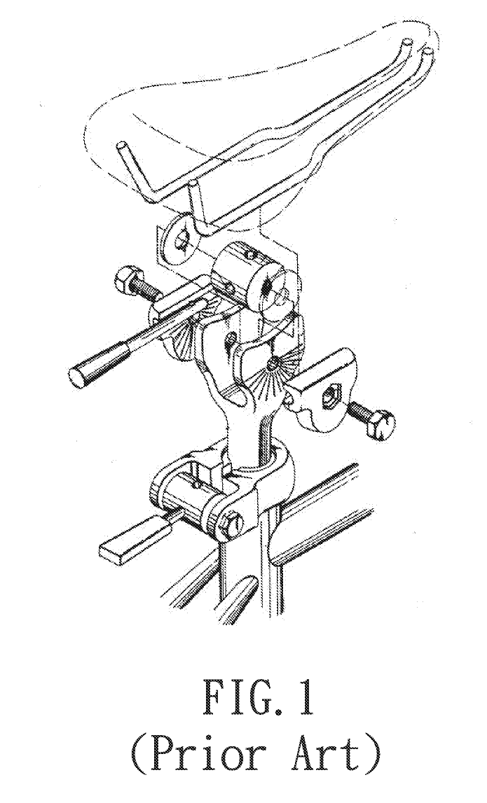

### DETAILED DESCRIPTION OF THE EMBODIMENTS

In the following detailed description, reference is made to the accompanying drawings, which form a part hereof. In the drawings, similar symbols typically identify similar components, unless context dictates otherwise. The embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein. It will also be understood that any reference to a first, second, etc. element in the claims or in the detailed description, is not meant to imply numerical sequence, but is meant to distinguish one element from another unless explicitly noted as implying numerical sequence.

The rotational mechanism of the present invention is designed with a displacement hole being disposed within an adjusting member, so as to facilitate the rotary adjustment of the seat by adjusting the position of the displacement hole and securing the relative position of the first and second clamp assemblies.

In one embodiment of the present invention, the first clamp assembly comprises a first inner clamp, a first outer clamp, and a first channel formed between the first inner clamp and the first outer clamp for receiving the rails of the seat.

In one embodiment of the present invention, the first inner clamp comprises a first conical protrusion disposed on a side of the first inner clamp facing to the adjusting member and for engaging the displacement hole of the adjusting member.

In one embodiment of the present invention, the first inner clamp comprises a threaded structure facing the adjusting member.

In one embodiment of the present invention, the second clamp assembly comprising a second inner clamp, a second outer clamp, and a second channel formed between the second inner clamp and the second outer clamp for receiving the rails of the seat.

In one embodiment of the present invention, the second inner clamp comprises a second conical protrusion disposed on a side of the second inner clamp facing the adjusting member and for engaging the displacement hole of the adjusting member.

In one embodiment of the present invention, the second inner clamp comprises a threaded structure facing the adjusting member.

In one embodiment of the present invention, the aperture of the accommodation member has a shape corresponding to an exterior of the adjusting member for engaging the adjusting member within the accommodation member.

In one embodiment of the present invention, the shape of the aperture of the accommodation member is one of an N-sided regular or an oblong, wherein the N is greater than or equal to 3.

In one embodiment of the present invention, an elastic member is disposed between the aperture of the accommodation member and the adjusting member.

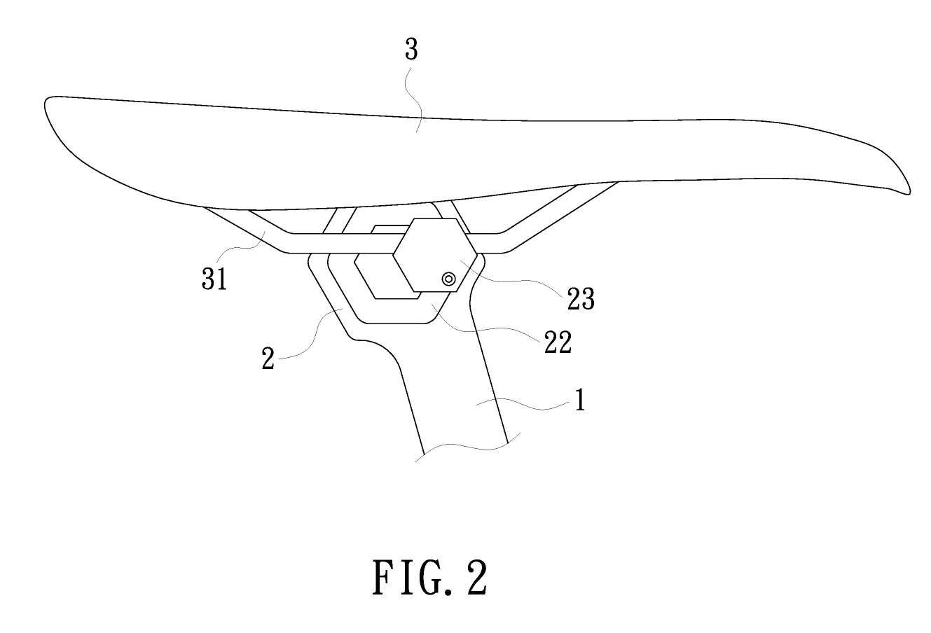

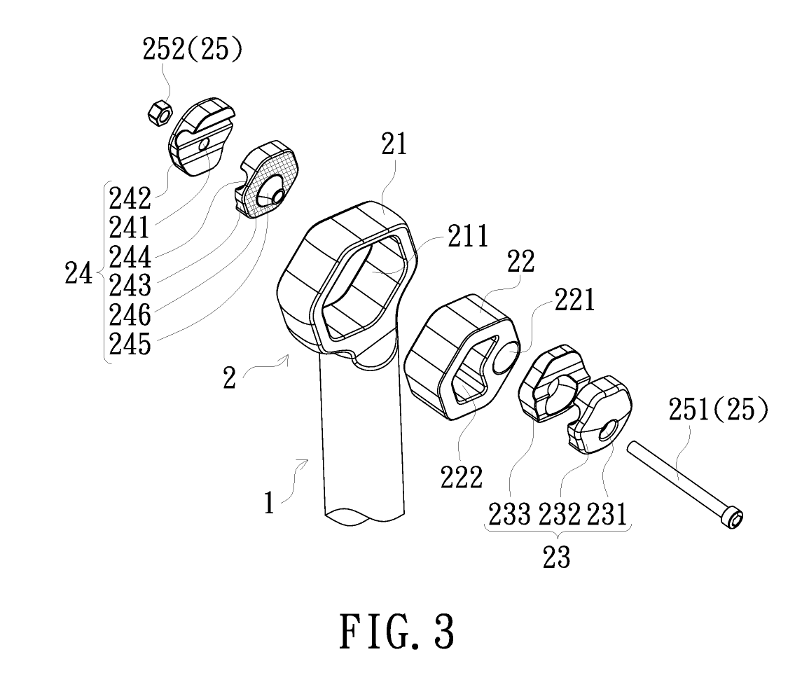

Depicted in FIGS. 2 and 3 is one embodiment of an inventive seat post incorporating features of the present invention which can be easily adjusted by users.

A seat post 1 for a bicycle is provided with one end thereof having a rail support 2 for securing two rails 31 of a seat 3. The rail support 2 comprises an accommodation member 21, an adjusting member 22, a first clamp assembly 23, a second clamp assembly 24 and a fastener 25. The accommodation member 21 has an aperture 211 for detachably engaging the adjusting member 22 within the aperture 211, and the adjusting member 22 comprises at least one displacement hole 221.

A first clamp assembly 23 is disposed on one side of the displacement hole 221 of the adjusting member 22 for clamping one of the rails 31, and the first clamp assembly 23 has a first through-hole 231. A second clamp assembly 24 is disposed on the other side of the displacement hole 231 of the adjusting member 22 for clamping another of the two rails 31, and the second clamp assembly 24 has a second through-hole 241. The fastener 25 comprises a bolt 251 and a nut 252, the bolt 251 is inserted through the first through-hole 231 of the first clamp assembly 23, the displacement hole 221 of the adjusting member 22, the second through-hole 241 of the second clamp assembly 24 to be tightened with the nut 252 for securing the adjusting member 22, the first clamp assembly 23 and the second clamp assembly 24 to the accommodation member 21.

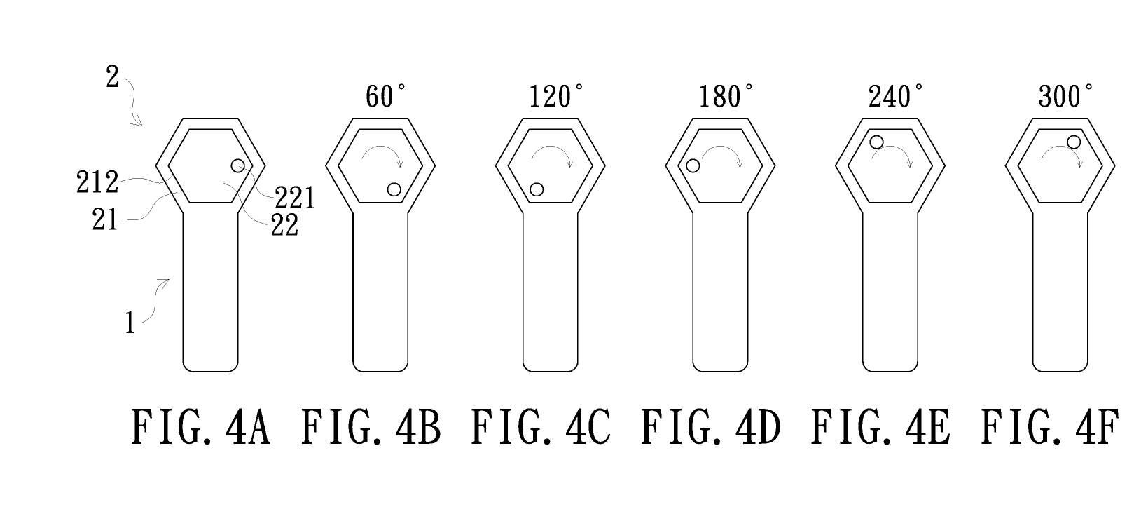

As depicted in FIGS. 4A to 4F, the motions of the adjusting member are captured into a series of static pictures. The adjusting member 22 has an engaging configuration and is designed to be received within the aperture 211 of the accommodation member 21 for securing the seat 3 to the seat post 1.

In other embodiments, an elastic member 212 may be disposed between the aperture 211 of the accommodation member 21 and the adjusting member 22 for facilitating detachment of the adjusting member 22 and reducing deterioration of the adjusting member 22 and the accommodation member 21 and for damping vibrations of the seat 3 during riding.

The number and location of the displacement hole 221 can be based on the desired offset of the seat 3 or to enable optimal positioning of a rider and to be located outwardly from the axis of the adjusting member 22. A pair of the first clamp assembly 23 and the second clamp assembly 24 are disposed on opposing sides of the adjusting member 22 for securing the two rails 31 of the seat 3 to the seat post 1. Furthermore, the adjusting member 22 has a strengthen structure 222, such as an opening, to enhance the intensity preventing deformation.

In the depicted embodiment, the aperture 211 and the adjusting member 22 may have an identical hexagon shape and the displacement hole 221 is disposed on one corner of the hexagon.

As illustrated in FIGS. 4B-4F, for instance if both of the aperture 211 and the adjusting member 22 are of a symmetrical hexagon shape, when the adjusting member 22 is rotated in multiples of 60 degree (i.e. one-sixth of 360 degree), the adjusting member 22 remains engaged within the accommodation member 21; however, the position of the displacement hole 221 of the adjusting member 22 would offset, causing displacement of the first clamp assembly 23 and the second clamp assembly 24. Therefore, the seat 3 can be adjusted to a position as the rider desires.

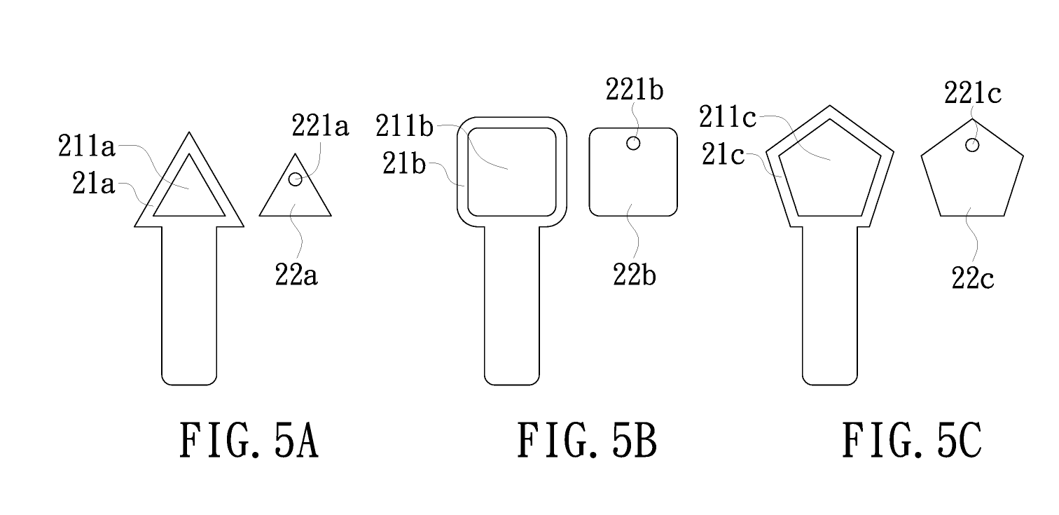

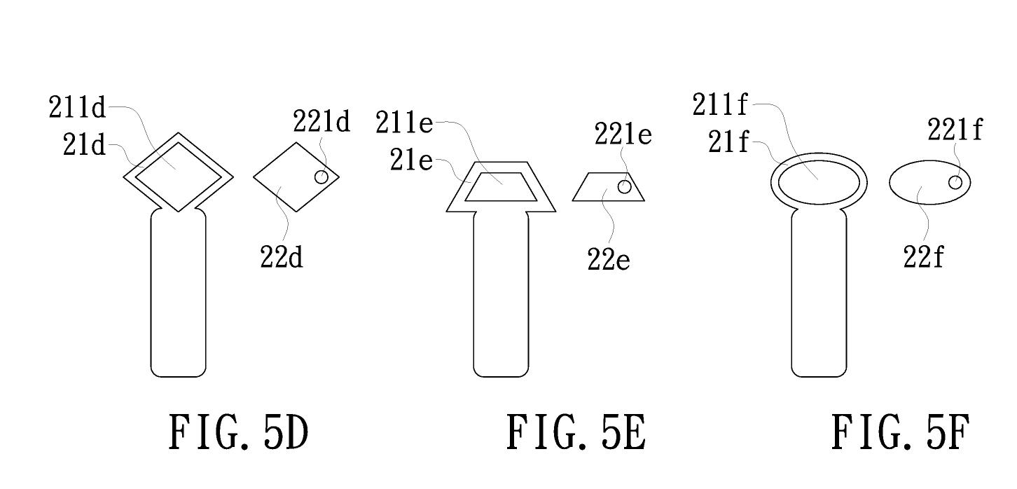

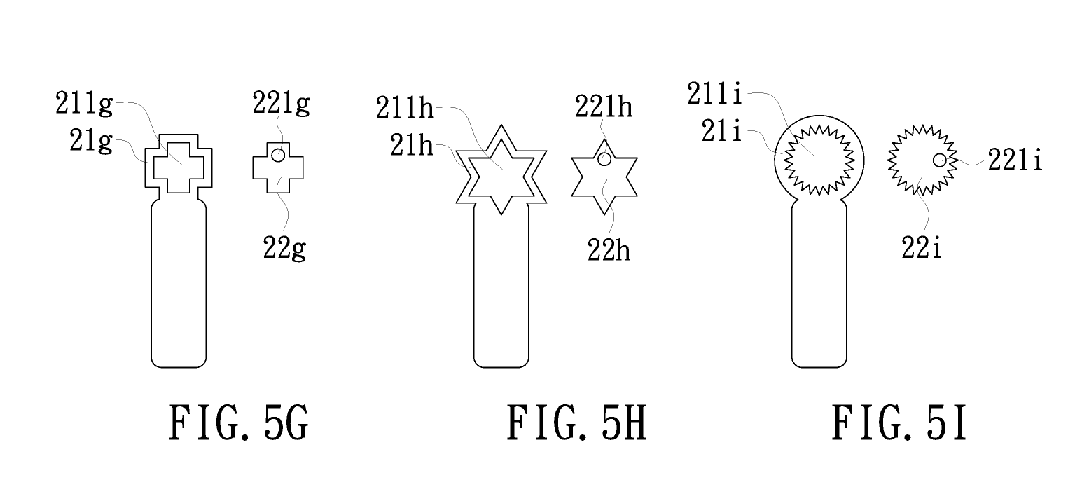

In alternative embodiments, as shown in FIGS. 5A, 5B and 5C, the shape of aperture 211a, 211b, 211c and the adjusting member 22a, 22b, 22c may be an N-gon, which is a polygon with N sides and is symmetrical to the axis of the adjusting member 22a, 22b, 22c; wherein N is greater than or equal to 3 (N≥3).

As aforementioned, since the shape of the adjusting member 22a, 22b, 22c is symmetrical to the axis, after rotating the adjusting member 22 for an optimal degree to engage the adjusting member 22 within the accommodation member 21a, 21 b, 21c, the shape of the adjusting member 22 would remain the same as before. The position of the displacement hole 221a, 221b, 221c of the adjusting member 22a, 22b, 22c would offset, causing displacement of the first clamp assembly 23 and the second clamp assembly 24. Therefore, the seat 3 can be adjusted to the position as the rider desires.

As shown in FIGS. 5A, 5B and 5C, the aperture 211a, 211b, 211c and the adjusting member 22a, 22b, 22c is designed with the shapes of triangle, square and pentagon. It is appreciated that these shapes depict several embodiments of the invention and are therefore not to be considered limiting of its scope.

In alternative embodiments, as shown in FIGS. 5D, 5E and 5F, the aperture 211d, 211e, 211f and the corresponding adjusting member 22d, 22e, 22f may be designed with the shapes of isosceles triangle, rectangle, trapezium, oblong, or any other shape that is symmetrically aligned with the vertical axis of the adjusting member 22d, 22e, 22f.

As aforementioned, since the shape of the adjusting member 22d, 22e, 22f is symmetrical to the vertical plane, after horizontal rotation of the adjusting member 22 to engage the adjusting member within the accommodation member 21d, 21e, 21f, the shape thereof would remain the same as before. The displacement of the seat 3 caused by the rotation of displacement hole 221 is small, such that the height of the seat 3 relative to the bicycle frame is almost the same as that before rotating the adjusting member 22; therefore, the rider feel comfort on extended rides without having to adjust the position of the seat post 1.

As shown in FIGS. 5D, 5E and 5F, the aperture 211d, 211e, 211f and the adjusting member 22d, 22e, 22f is designed with the shapes of rhombus, trapezium and oblong. It is appreciated that these shapes depict several embodiments of the invention and are therefore not to be considered limiting of its scope.

In alternative embodiments, as shown in FIGS. 5G, 5H and 5I, the adjusting member 22g, 22h, 22i has the shapes of polygon or circular that is symmetrical to the axis of the adjusting member 22 as the base does, and further includes an engaging portion disposed on the base. Accordingly, the aperture 211g, 211h, 211i has a plurality of grooves disposed radially inward and having the shape corresponding to the adjusting member 22g, 22h, 22i. In one embodiment, the polygon has N sides and the number of N is greater than or equal to 3 (N≥3), the number of groove is greater than or equal to 2.

As aforementioned, since the shape of the adjusting member 22g, 22h, 22i is symmetrical to the axis, after rotating the adjusting member 22 for an optimal degree to engage the adjusting member 22 within the accommodation member 21, the shape of the adjusting member 22 would remain the same as before. The engaging portion is not limited to any size or any shape, and may be integrated into the aperture 211g, 211h, 211i, in addition to the adjusting member 22g, 22h, 22i. The displacement of the seat 3 caused by the rotation of the displacement hole 221g, 221 h, 221i is small such that the height of the seat 3 relative to the bicycle frame is almost the same as that before rotating the adjusting member 22g, 22h, 22i; therefore, the rider feel comfort on extended rides without having to adjust the position of the seat post 1.

As shown in FIG. 5G, the adjusting member 22g comprises a square base and has a plurality of square engaging portions mounted on one of four sides. The base and the engaging portions can be integrally formed a single unitary structure which has a cross shaped exterior if the length of each side of the engaging portion is the same as one side of the square base. Accordingly, the aperture 211g is disposed radially inward and has a shape corresponding to the exterior of the integrated adjusting member 22g.

As shown in FIG. 5H, the adjusting member 22h comprises a hexagon base. A plurality of triangular engaging portions are each mounted on one of six sides of the hexagon base to integrally forma single unitary structure that has a star shaped exterior. Accordingly, the aperture 211h is disposed radially inward and has a shape corresponding to the exterior of the integrated adjusting member 22h.

As shown in FIG. 5I, the adjusting member 22i comprises a circular base. A plurality of acute triangular engaging portions are mounted thereon to integrally forma single unitary structure that has a gear-like exterior. Accordingly, the aperture 211i is disposed radially inward and has a shape corresponding to the exterior of the integrated adjusting member 22i.

Additionally, the aperture 211 and the adjusting member 22 may be designed with any shape and not to be limited by the above-described examples.

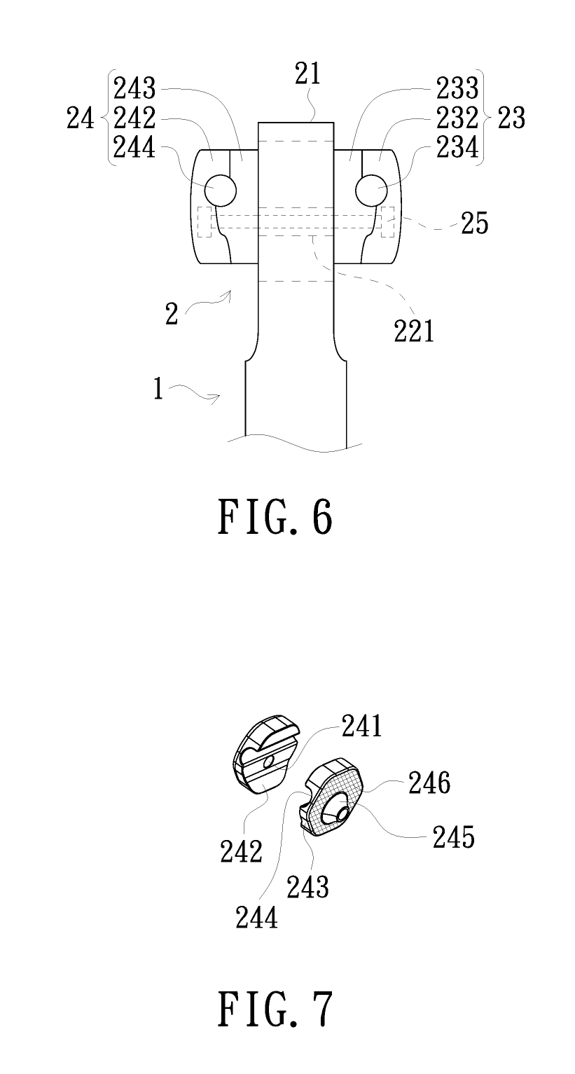

As shown in FIG. 6, the rail support 2 further comprises a first clamp assembly 23 and a second clamp assembly 24 disposed on two sides of the displacement hole of the adjusting member 22 respectively. The first clamp assembly 23 comprises a first outer clamp 232, a first inner clamp 233, and a first channel 234 formed between the first outer clamp 232 and the first inner clamp 233 and is configured to clamp the rail 31 for securing the seat 3.

Similarly to the first clamp assembly 23, the second clamp assembly 24 also comprises a second outer clamp 242, a second inner clamp 243, and a second channel 244 formed between the second outer clamp 242 and the second inner clamp 243 and is configured to clamp the other rail 31 for securing the seat 3.

Additionally, first clamp assembly 23 comprises the first outer clamp 232 having a portion surface with recession or protrusion. The first inner clamp 233 has a portion surface to correspond to the portion surface of the first outer clamp 232 for fastening engagement of the first clamp assembly 23.

Depicted in FIG. 7 is one embodiment of the second clamp assembly 24. The second clamp assembly 24 includes a second inner clamp 243 having a surface mounted with a second conical protrusion 245 facing the adjusting member 22 and aligned with the axis of the second through-hole 241.

When the second clamp assembly 24 and the adjusting member 22 are installed together, the second conical protrusion 245 is inserted into the displacement hole 221 to facilitate alignment between the second through-hole 241 and the displacement hole 221 and to stabilize the second clamp assembly 24 and the adjusting member 22.

Additionally, an uneven structure such as a threaded structure 246 is formed on the surface of the second inner clamp 243 of the second clamp assembly 24 facing the adjusting member 22. The uneven structure is designed to provide friction between the second inner clamp 243 and the adjusting member 22 and to stabilize the tightness therebetween.

Furthermore, in one embodiment, the conical protrusion and the uneven structure can be selectively integrated into the inner clamp of the other clamp assembly. For example, a first conical protrusion 235 with a threaded structure may be disposed on the first inner clamp 233 facing the adjusting member 22.

The seat post of the present invention comprises a rail support connected to one end of the seat post. The rail support has an adjusting member with a displacement hole, and a pair of clamp assemblies are disposed on two sides of the displacement hole of the adjusting member for clamping the rails. Once the position of the displacement hole of the adjusting member changes, the position of the pair of clamp assemblies and the seat would easily change correspondingly. Therefore, such adjustability of the seat allows the rider to adjust the seat easily and lead to comfort on extended rides without having to adjust the position of the seat post.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A seat post for a bicycle with one end thereof having a rail support for securing two rails of a seat, the rail support comprising:
an accommodation member having an aperture;
an adjusting member detachably engaged within the aperture of the accommodation member and having at least one displacement hole;
a first clamp assembly disposed on one side of the displacement hole of the adjusting member for clamping one of the two rails, and the first clamp assembly having a first through-hole;
a second clamp assembly disposed on another side of the displacement hole of the adjusting member for clamping another of the two rails, and the second clamp assembly having a second through-hole; and
a fastener inserting through the first through-hole of first clamp assembly, the displacement hole of the adjusting member, and the second through-hole of the second clamp assembly to secure the adjusting member to the accommodation member.

2. The seat post according to claim 1, wherein the first clamp assembly comprises a first inner clamp, a first outer clamp and a first channel formed between the first inner clamp and the first outer clamp for receiving the rails of the seat.

3. The seat post according to claim 2, wherein the first inner clamp comprises a first conical protrusion disposed on a side of the first inner clamp facing the adjusting member and for engaging the displacement hole of the adjusting member.

4. The seat post according to claim 3, wherein the first inner clamp comprises a threaded structure facing the adjusting member.

5. The seat post according to claim 1, wherein the second clamp assembly comprises a second inner clamp, a second outer clamp and a second channel formed between the second inner clamp and the second outer clamp for receiving the rails of the seat.

6. The seat post according to claim 5, wherein the second inner clamp comprises a second conical protrusion disposed on a side of the second inner clamp facing the adjusting member and for engaging the displacement hole of the adjusting member.

7. The seat post according to claim 6, wherein the second inner clamp comprises a threaded structure facing the adjusting member.

8. The seat post according to claim 1, wherein the aperture of the accommodation member has a shape corresponding to an exterior of the adjusting member for engaging the adjusting member within the accommodation member.

9. The seat post according to claim 8, wherein the shape of the aperture of the accommodation member is one of an N-sided regular polygon or an oblong, wherein the N is greater than or equal to 3.

10. The seat post according to claim 8, further comprising an elastic member disposed between the aperture of the accommodation member and the adjusting member.

11. The seat post according to claim 1, wherein the fastener further comprises a bolt and a nut, the bolt is inserted through the first through-hole of the first clamp assembly, the displacement hole of the adjusting member, the second through-hole of the second clamp assembly to be tightened with the nut.

12. The seat post according to claim 1, wherein a shape of an exterior of the adjusting member is a polygon with N sides and symmetrical to an axis of the adjusting member, and the aperture of the accommodation member further comprises a plurality of grooves disposed radially inward and having a shape corresponding to the exterior of the adjusting member for engaging with the adjusting member, wherein the N is greater than or equal to 3.

13. The seat post according to claim 12, wherein the shape of the exterior of the adjusting member is a hexagon and the displacement hole is disposed on one corner of the hexagon.

14. The seat post according to claim 1, wherein a shape of an exterior of adjusting member is one of a rhombus, a trapezium and an oblong and is symmetrically aligned with a vertical axis of the adjusting member, and the aperture of the accommodation member further comprises a plurality of grooves disposed radially inward and having a shape corresponding to the exterior of the adjusting member for engaging with adjusting member.

15. The seat post according to claim 1, wherein the adjusting member comprises a square base, a plurality of square engaging portions are each mounted on one of four sides of the square base to integrally form a single unitary structure having a cross shaped exterior, and the aperture of the accommodation member has a plurality of grooves disposed radially inward and having a shape corresponding to the exterior of the adjusting member for engaging with adjusting member.

16. The seat post according to claim 1, wherein the adjusting member comprises a hexagon base, a plurality of triangular engaging portions are each mounted on one of six sides of the hexagon base to integrally form a single unitary structure having a star shaped exterior, and the aperture of the accommodation member has a plurality of grooves disposed radially inward and having a shape corresponding to the exterior of the adjusting member for engaging with adjusting member.

17. The seat post according to claim 1, wherein the adjusting member comprises a circular base, a plurality of acute triangular engaging portions are mounted thereon to integrally form a single unitary structure having a gear-like exterior, and the aperture of accommodation member has a plurality of grooves disposed radially inward and having a shape corresponding to the exterior of the adjusting member for engaging with adjusting member.

18. A seat post for a bicycle having one end thereof mounted with a rail support to clamp two rails of a seat, the rail support comprising:
an accommodation member having an aperture; and
an adjusting member detachably engaged within the aperture of the accommodation member and having at least one displacement hole;
wherein a shape of an exterior of the adjusting member is symmetrical to an axis of the adjusting member, and the aperture of the accommodation member further comprises a number plurality of grooves disposed radially inward and having a shape corresponding to the exterior of the adjusting member for engaging with the adjusting member.

19. The seat post according to claim 18, further comprising a pair of clamp assemblies disposed on two sides of the displacement hole of the adjusting member for clamping the two rails of the seat.
